(19) United States
(12) Patent Application Publication
(10) Pub. No.: US 2002/0198737 A1
(43) Pub. Date: Dec. 26, 2002

(54) Method in trade

(76) Inventor: Jarkko Valtanen, Helsinki (FI)

Correspondence Address: SWIDLER BERLIN SHEREFF FRIEDMAN, LLP, 3000 K STREET, NW, BOX IP, WASHINGTON, DC, 20007, US

(21) Appl. No.: 10/182,562

(22) PCT Filed: Jan. 30, 2001
(86) PCT No.: PCT/FI01/00086

(30) Foreign Application Priority Data
Jan. 31, 2000 (FI) 20000194

(51) Int. Cl. G06F 17/60

(52) U.S. Cl. 705/1; 705/26

(57) ABSTRACT

A method in trade, wherein a customer (A) effects a purchase for acquiring a product, a service, a game voucher and/or the like from a service provider (PT), such as a seller (M), a server (P) and/or the like, in which process the customer chooses, confirms and/or pays for their purchase, whereby the service provider (PT), if necessary after the verification of personal data, credit information and/or the like, confirms that the purchase transaction has been properly conducted and transmits to the customer at least a receipt or the like in an electronic mode substantiating the legitimacy of a purchase transaction and for storing the same in an electronic memory (C) possessed by the customer (A). Following an accepted purchase transaction, the customer (A) is supplied with a so-called smart certificate of purchase (X), which contains an independent information package, such as a file or the like, by means of which a purchase transaction between the customer (A) and the service provider (PT) is immediately identifiable and venfiable in procedures regarding an acquired product, service or the like, such as a transfer of the same to another customer, a resale, a redemption or the like exploitation.

The invention relates to a method in trade, wherein a customer efects a purchase for acquiring a product, a service, a came voucher and/or the like from a service provider, such as a seller, a server and/or the like, in which process the customer chooses, confirms and/or pays for their purchase, whereby the service provider, if necessary after the verification of personal data, credit information and/or the like, confirms that the purchase transaction has been properly conducted and transmits to the customer at least a receipt or the like in an electronic mode substantiating the legitimacy of a purchase transaction and for storing the same in an electronic memory possessed by the customer.

In electronic trade or commerce, for example, it is nowadays possible for customers to claim an acquired product/service e.g. by means of customer identifiers. Thus, in the process of a purchase, the customer discloses a required customer identifier, such as their patronage number, to a service provider to be stored in their database along with purchase data. When a customer wishes to claim e.g. a purchased product/service, they are identified again, after which the service provider delivers the product/service to the customer on the basis of data present in their database.

It is also possible that, in the process of a purchase transaction, the customer be given a claim-entitling code, whereby they may claim e.g. an acquired product/service. In practice, codes of this type are compiled in such a way that the code only contains a random serial number or another random alphanumeric character code, whereby the customer is able to claim a purchased product/service from a service provider. This random serial number functions like a customer identifier, the service provider having their database stored with customer-specific purchase information coupled with the serial number. Thus, the customer discloses to a service provider a code, which they have received in the process of claiming a discussed product/service, after which the service provider delivers the product/service to the customer on the basis of information present in their database.

On the other hand, e.g. the International patent publication WO 97/45814 discloses a principle regarding a method for electronic trade or commerce, which first of all makes use of a mobile phone and in which, secondly and on the other hand, a customer's mobile phone is supplied with a confirmation regarding a duly completed purchase transaction. In this case, however, the confirmation delivered to a customer is only intended to acknowledge a properly conducted purchase transaction, whereby e.g. an electronic receipt transmitted to a customer's mobile phone is of no further use in any other way with regard to promoting or finalizing a commercial transaction.

Consequently, the traditionally implemented trade arrangements continue to be hampered by problems as follows:

a service provider must maintain a database regarding all completed transactions, which means that the service provider shall end up with a data processing system which is heavy-duty and costly to upkeep,

electronic readers, such as smart card readers, bar code readers or other such devices, used for reading a code based on a customer identifier or a random number, require a real-time and permanent connection to a database, which is why the service provider's data processing system is burdened by high maintenance and running costs,

when using the prior art systems, the fluency of transactions between a service provider and customers is particularly impeded by the fact that such systems are “dumb” in the sense that, when operating the same, the customer is generally forced to handle most transaction-related, practical procedures manually themselves,

when using current customer identification systems, a customer is not able to remain anonymous in the process of claiming an acquired purchase or otherwise exploiting the same.

It is an object of a method according to the present invention to provide a decisive improvement regarding the above problems, and thus to substantially raise the prior art currently existing in the field. In order to accomplish this object, a method of the invention is primarily characterized in that, following an accepted purchase transaction, the customer is supplied with a so-called smart certificate of purchase, which contains an independent information package, such as a file or the like, by means of which a purchase transaction between a customer and a service provider is immediately identifiable and verifiable in procedures regarding an acquired product, service or the like, such as a transfer of the same to another customer, a resale, a redemption or the like exploitation.

One of the most significant benefits offered by a method of the invention can be said to be the simplicity and functional reliability of its operating principle, whereby the reliability of electronic commerce can be practically secured in the most diversified of circumstances and applications, while at the same time minimizing a need for extra massive data processing hardware and communications. First of all, one crucial advantage gained by a method of the invention is that a service provider is able to significantly simplify their stock of permanent hardware as there is no longer a need to transmit information regarding individual service incidents in the current extent further to other servers or ar entire sales network. The completion of a commercial transaction is also markedly simplified both from the viewpoint of a service provider and a customer, since e.g. an acquired product or service can be claimed simply and immediately by establishing communication between the customer's data processing device and e.g. a so-called automatic reader, without having to establish separate communication with the service provider. Thus, in a preferred application of the invention, in the process of handing over a product, service and/or the like acquired by a customer, a service provider only needs to verify that the certificate of purchase present in the customer's data processing device is definitely genuine, not e.g. forged or previously used.

One such way of effecting the verification of a certificate of purchase is to protect transaction data contained therein e.g. by a hard-to-break concealment, such as encryption. Thus, a service provider must maintain in their database e.g. a confidential key consistent with a particular certificate of purchase, capable of verifying the transaction data present in the certificate of purchase. In order to disable the use of one certificate of purchase for claiming the same product/service twice, the service provider may naturally provide their database also with information about whether or not the certificate of purchase has already been used. Similarly, the database may also be provided with information about how many times or for how long a certificate of purchase is valid, whether it can be used for a number of times or only at certain points of time. Hence, in this respect, the essential significance of the invention is that the service provider need not keep their database loaded with all information about all transactions, since a substantial part thereof is reliably stored in a smart certificate of purchase transmitted to a customer.

When all information to be identified and required for a transaction is included in a smart certificate of purchase, the reader of a service provider, as the acquisition is being finalized, such as e.g. in the process of delivering a product/service, need not be in a real-time and permanent communication with the service provider's database, which is currently a prerequisite, especially in systems based on a customer identifier. By virtue of this, a method of the invention is capable of substantially reducing the computer hardware acquisitions of a service provider, as well as cutting down maintenance costs resulting therefrom.

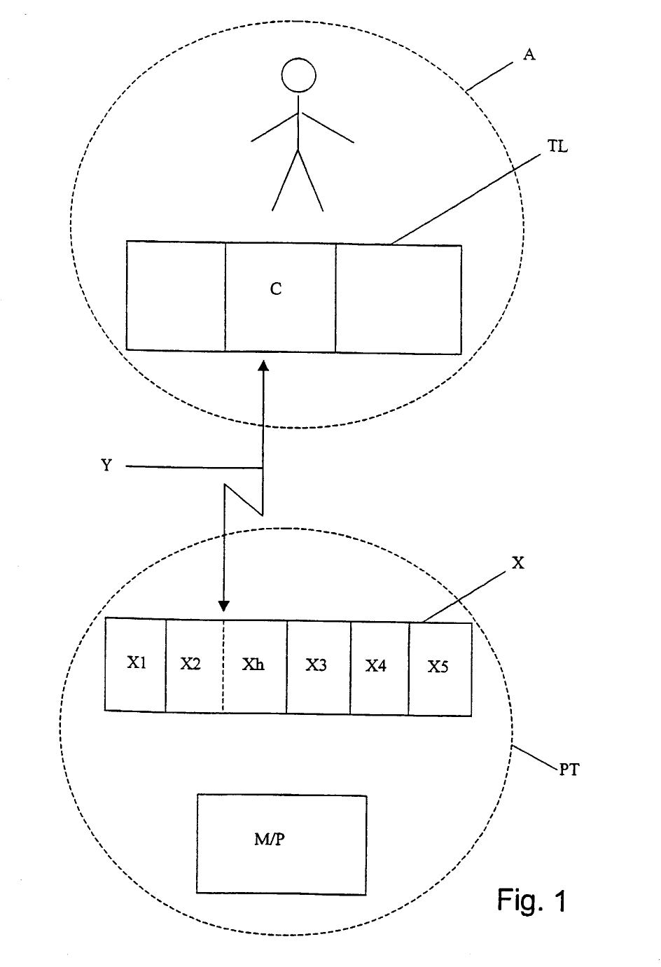

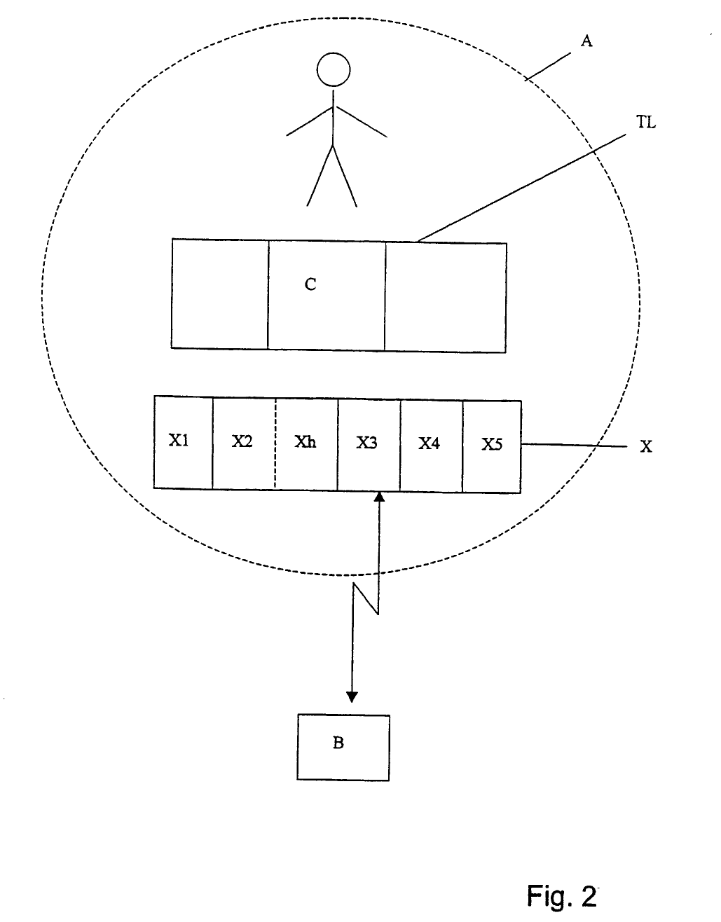

In the following specification the invention will be described in detail with reference made to the accompanying drawing, wherein FIG. 1 depicts one preferred operating principle for a method of the invention in connection with an actual purchasing process, and FIG. 2 in connection with placing a claim or the like for an acquisition constituting the commercial transaction.

The invention relates to a method in trade or commerce, wherein a customer A effects a purchase in order to acquire a product, a service, a game voucher and/or the like from a service provider PT, such as a seller M, a server P and/or the like. At this point, the customer chooses, confirms and/or pays for their purchase, whereby the service provider, if necessary after the verification of personal data, credit information and/or the like, confirms that the purchase transaction has been properly conducted and transmits to the customer a voucher or the like, substantiating at least the legitimacy of the purchase transaction, in electronic mode for storing the same in an electronic memory C possessed by the customer A. Following an accepted purchase transaction, the customer A is supplied with a so-called smart certificate of purchase X, which contains an independent information package, such as a file or the like, by means of which a purchase transaction between the customer A and the service provider PT is immediately identifiable and verifiable in procedures regarding an acquired product, service or the like, such as a transfer of the same to another customer, a resale, a redemption or the like exploitation.

In a preferred application of the method, the customer effects their purchase by way of a communication link Y by establishing a contact with the server P, which is at least in a data transfer communication with the service provider PT and which, following an accepted purchase transaction, transmits an electronic voucher, entitling an acquisition constituting the commercial transaction, to an electronic memory C of a portable data processing device TL, such as a PC, a calculator, a telephone, an electronic memory device or the like, possessed by the customer, preferably in a scrambler-system processed mode, such as encrypted, particularly for securing the legitimacy of a commercial transaction. Hence, the voucher stored by the customer A is verified at the time of exploiting, such as claiming or the like, a product, a service, a game obligation and/or the like, preferably by means of a so-called automatic reader B according to the principle shown in FIG. 2. At this point, the reader B is used to enable the finalization of a commercial transaction by way of establishing a contact directly between the same and the data processing device TL of the customer A, by checking at the smart certificate of purchase X for its validity by decrypting a code present therein by means of a confidential key for enabling the reading of purchase transaction data stored in the certificate of purchase and for finalizing the commercial transaction.

In a further preferred application of the method, the smart certificate of purchase X is used for supplying the customer X with general information regarding the acquisition constituting a commercial transaction, such as a handbill for a public event, information regarding a purchased product, service and/or a service provider and/or the like.

In yet another preferred application of the method, the certificate of purchase is provided with a visual element X1 to be displayed to a customer, which contains a graphic representation for information regarding an acquired product, service, game obligation and/or the like, such as a concrete receipt, a ticket, a game voucher and/or the like.

In a yet further preferred application, the smart certificate of purchase X is provided with a customer identifier X2, such as a social security number or a part of it, an LY-code, a mobile phone PIN-code, a Smart Trust feature and/or the like, for enabling the service provider PT to verify that a procedure relating to a product, a service, a game voucher and/or the like, constituting a commercial transaction, is only performed by the customer A entitled to such procedure.

Furthermore, it is possible to use a smart certificate of purchase in such a way that e.g. the readers B of a service provider are provided at given intervals with confidential keys required for decoding the certificate of purchase X for enabling the reader B to read the transaction data contained in the certificate of purchase. On the basis of transaction data decrypted from a certificate of purchase, the service provider PT is thus capable of delivering a product/service to the customer A. Hence, however, the smart code X need not always contain all information regarding an acquisition constituting a transaction, if e.g. the identification and verification of transactions are effected e.g. by means of a customer identification system, whereby the information regarding the acquisition constituting a transaction is kept in storage in the service provider's PT database.

In a yet further preferred application of the method, the smart certificate of purchase X is stored in a customer's electronic memory C in such a way that its exploitation can be done anonymously, whereby the customer A need not reveal their identity in the process of claiming or otherwise realizing a product, a service, a game voucher and/or the like purchased thereby.

In a still another preferred application of the method, the smart certificate of purchase X transmitted to a customer is accompanied by so-called hyperlinks Xh or the like for guiding the customer A with the help of their data processing device TL and/or the internet to sources of further information, services and/or the like.

In another preferred application of the method, the smart certificate of purchase is provided with an information element X3, which contains information transmitted to the customer A, such as word processing documents, SAP-mode documents, graphic representations and/or the like, which the customer can visualize by means of their own data processing device by clicking a hyperlink Xh or the like incorporated in the visual element X2 included therein.

In a further preferred application of the method, the smart certificate of purchase is provided with a service element X4, which contains data such as the service provider's IP address or other such information, on the basis of which a further processing of the certificate of purchase X, such as a sale thereof, a transfer to another customer, its updating and/or the like, is possible to carry out by means of a so-called automatic establishment of communication with the service provider PT.

In another preferred application of the method, the smart certificate of purchase is provided with identification element X5 containing necessary information, on the basis of which the customer's A right to a purchase transaction recorded therein is specifiable in such a way that a commercial transaction involving an acquired product, service, game voucher and/or the like can be brought to a conclusion.

The data suppliable in the foregoing service element X4 refers e.g. to information, the disclosure of which to a customer is not necessarily desirable, but which serves to streamline, expedite or otherwise facilitate transactions or auxiliary functions associated therewith. By means of such information, facilitating the automation of e.g. services offered by a service provider, the customer will be able to easily and quickly sell e.g. an acquired ticket safely to another customer through the intermediary of the service provider. Thus, in comparison with currently available systems, the smart certificate of purchase provides transaction processes which are quicker, more efficient, as well as simpler from the point of view of both a service provider and a customer, since the smart certificate of purchase carries all necessary information, whereby the auxiliary functions associated with a transaction can be automated as extensively as possible.

Moreover, the above-mentioned anonymous realization is intended to make sure that at no point of a commercial transaction is the customer forced to disclose information about themselves to a service provider. This is attributable to the fact that the smart certificate of purchase is able to hold within itself all necessary information required by the service provider PT for delivering to a customer a product, a service or e.g. a game voucher acquired by this customer. This is a distinct advantage over e.g. currently available customer identification systems, since a customer can never operate anonymously within a framework provided by the latter. Naturally, in accordance with the foregoing, the smart certificate of purchase can, if necessary, be provided with an incorporated customer identifier if the service provider wishes to make sure that a commercial transaction is brought to a conclusion by a correct customer. Consequently, the smart certificate of purchase enables the possibility of anonymity, yet does not exclude the possibility of making the use of a certificate of purchase safe by incorporating therein some necessary customer identifiers, such as a PIN code or the like.

It is obvious that the invention is not limited to the application described or depicted above, but it can be subjected to a wide variety of modifications within the scope of the basic inventive concept. First of all, it is self-evident that all possible future portable devices with on-line capabilities will be relevant in operations consistent with the basic inventive concept, i.e. when a customer effects acquisitions by establishing a contact with the server of a service provider or by being in a direct contact with a seller. In this context, it is naturally possible to establish an on-line communication between the reader of a service provider or a seller and the data processing device of a customer by exploiting the most diverse of wired or preferably wireless contacting arrangements, such as radio frequency, infrared, Bluetooth arrangements or the like.

Naturally, the smart certificate of purchase may thus carry information capable of identifying and verifying transactions, a wide range of information capable of automating, streamlining and expediting transactions, as well as other information of extra value to a customer, all such information not being always necessary in all applications at the same time. In some applications, the smart certificate of purchase may only carry transaction identifying and verifying information, nothing else. On the other hand, in some applications the identification and verification of a transaction can be handled e.g. by means of customer identification systems, but a smart or intelligent code can nevertheless be used for automating and streamlining transactions and for supplying information to a customer thereby. In some applications, however, the smart certificate of purchase may only carry information intended for a customer, nothing else. In some applications, it may, in turn, contain information capable of automating transactions, and nothing else, etc. Of course, it is also obvious that the smart certificate of purchase need not necessarily hold within itself transaction information, if the identification and verification of transactions are effected by means of e.g. customer identification systems, whereby transaction information is kept in storage in the service provider's database.

1. A method in trade, wherein a customer (A) effects a purchase for acquiring a product, a service, a game voucher and/or the like from a service provider (PT), such as a seller (M), a server (P) and/or the like, in which process the customer chooses, confirms and/or pays for their purchase, whereby the service provider (PT), if necessary after the verification of personal data, credit information and/or the like, confirms that the purchase transaction has been properly conducted and transmits in an electronic mode to the customer a certificate of purchase storable in an electronic memory (C) possessed by the customer (A), which enables the claiming/exploitation of a product, a service, a game voucher and/or the like, characterized in that the customer (A) is supplied with a so-called smart certificate of purchase (X) containing an independent information package, such as a file or the like, by means of which transactions made available to the customer (A), such as information searches, use of extra services and/or the like, and/or a further processing of the certificate of purchase (X), such as a sale thereof, a transfer to another customer, its updating and/or the like, are implementable by using a so-called automated establishment of communication with the service provider (PT).

2. A method as set forth in claim 1, characterized in that the smart certificate of purchase (X) is provided with a customer identifier (X2), such as a PIN code, especially for enabling the service provider (PT) to verify that a transaction directed to a product, a service, a game voucher and/or the like, constituting an object of trade, is only conducted by the customer (A) authorized to do so.

3. A method as set forth in claim 1 or 2, characterized in that the smart certificate of purchase (X) is stored in a customer's electronic memory (C) while provided with the customer identifier (X2), such as a PIN code, in such a way that the exploitation thereof is implementable anonymously, whereby the customer (A) need not disclose their identity in the process of claiming or otherwise exploiting a product, a service, a game voucher and/or the like purchased by said customer.

4. A method as set forth in any of the preceding claims 1-3, characterized in that, along with the smart certificate of purchase (X), a customer is supplied with so-called hyperlinks or the like for guiding the customer (A) through the intermediary of their data processing device (TL) and/or the internet to sources of further information, services and/or the like.

5. A method as set forth in any of the preceding claims 1-4, characterized in that the smart certificate of purchase is provided with an information element (X3), which carries information transmitted to the customer (A), such as word processing documents, SAP-mode documents, graphic representations and/or the like, which the customer can visualize by means of their own data processing device (TL) by clicking a hyperlink or the like incorporated in the visual element (X2) included therein.

6. A method as set forth in any of the preceding claims 1-5, characterized in that the smart certificate of purchase is provided with a service element (X4), which carries data, such as an IP address for the service provider (PT) or other such information, on the basis of which a further processing of the certificate of purchase (X), such as a sale thereof, a transfer to another customer, its updating and/or the like, is implementable by using a so-called automated establishment of communication with the service provider (PT).

7. A method as set forth in any of the preceding claims 1-6, characterized in that the smart certificate of purchase is provided with an identification element (X5) containing necessary information, on the basis of which the customer's (A) right to a purchase transaction recorded therein is specifiable in such a way that, if necessary, the commercial transaction relating to an acquired product, service, game voucher and/or the like can be brought to a conclusion, such that the customer is able to safeguard their anonymity as desired.
